(19) United States
(12) Patent Application Publication
(10) Pub. No.: US 2007/0288164 A1
(43) Pub. Date: Dec. 13, 2007

(54) INTERACTIVE MAP APPLICATION

(75) Inventors: Stephen R. Gordon, Bellevue, WA (US); Maria B. Belousova, Redmond, WA (US); Steve Lombardi, Seattle, WA (US); Gur Kimchi, Bellevue, WA (US); Chandrasekhar Thota, Redmond, WA (US); Chi Hang Tam, Issaquah, WA (US)

Correspondence Address: AMIN. TUROCY & CALVIN, LLP, 24TH FLOOR, NATIONAL CITY CENTER, 1900 EAST NINTH STREET, CLEVELAND, OH, 44114, US

(73) Assignee: MICROSOFT CORPORATION, Redmond, WA (US)

(21) Appl. No.: 11/561,693

(22) Filed: Nov. 20, 2006

Related U.S. Application Data
(60) Provisional application No. 60/804,243, filed on Jun. 8, 2006.

(51) Int. Cl. G01C 21/00

(52) U.S. Cl. 701/213

(57) ABSTRACT

Provided is the ability for multiple users to dynamically interact and exchange real time information though utilization of a real time communication application and a mapping application. The multiple users can discover and share location specific information or exchange real time location information. Relevant information can be shared, such as points of interest, driving directions, annotations, etc. in a collaborative environment. Also provided is the ability to create a drawing or plan directly on the map in a collaborative manner.

### CROSS-REFERENCE TO RELATED APPLICATIONS

This application claims the benefit of U.S. Provisional Application Ser. No. 60/804,243, filed Jun. 8, 2006, entitled “INTERACTIVE MAP APPLICATION,” the entirety of which is incorporated herein by reference.

### BACKGROUND

People utilize computing devices as a means to communicate and stay “connected” while moving from place to place and such communication can be instantaneous or in real time. Such information exchange can occur by entering text, visual, audio, or other forms of information into a display area and communicate with another user in a back-and-forth manner. This instantaneous communication allows users in disparate locations to communicate in a real time fashion with or without using another means of communication (e.g., telephone). Technology of such mobile computing devices has advanced to the point where data regarding any desired content is readily available. For example, many people utilize mapping technologies to view areas of interest, such as a hometown or a vacation spot, to obtain driving directions, or for a variety of reasons.

Mapping applications have become common and interaction with such map applications is user specific and tailored for a specific user. Users that wish to share mapping information with another person do not currently have the capabilities since mapping applications are set up for individual use. Therefore, maps and other information are not easily shared among users. To share such information, the participants must view the same display or screen or the user has to print or save the map or information of interest and transfer such document or file to the other user. Thus, there is no real time sharing available as it relates to mapping or other types of applications nor can the users interact and collaborate on a project.

### SUMMARY

The following presents a simplified summary in order to provide a basic understanding of some aspects of the disclosed embodiments. This summary is not an extensive overview and is intended to neither identify key or critical elements nor delineate the scope of such embodiments. Its sole purpose is to present some concepts of the described embodiments in a simplified form as a prelude to the more detailed description that is presented later.

In accordance with one or more embodiments and corresponding disclosure thereof, various aspects are described in connection with an interactive map application that can be implemented through a real time messaging system (e.g., Instant Messenger, or other real-time communication techniques) and a mapping application (e.g., Virtual Earth, or other mapping platforms). Various embodiments can provide discovering location-specific information, exchanging real time location information among users participating in an application session, and/or sharing relevant information, such as points of interest, driving directions, and annotations in a collaborative environment. The one or more users can view the same information and make changes or annotations to such information at substantially the same time. The annotations or other changes made to the information can be saved and shared with the same or other users.

To the accomplishment of the foregoing and related ends, one or more embodiments comprise the features hereinafter fully described and particularly pointed out in the claims. The following description and the annexed drawings set forth in detail certain illustrative aspects and are indicative of but a few of the various ways in which the principles of the embodiments may be employed. Other advantages and novel features will become apparent from the following detailed description when considered in conjunction with the drawings and the disclosed embodiments are intended to include all such aspects and their equivalents.

### BRIEF DESCRIPTION OF THE DRAWINGS

FIG. 1 illustrates a system that facilitates an interactive mapping session.

FIG. 2 illustrates another system that provides interactive map sessions between two or more users.

FIG. 3 illustrates a schematic representation of a communication system in accordance with the disclosed embodiments.

FIG. 4 illustrates an exemplary screen shot of an user session.

FIG. 5 illustrates another exemplary screen shot of an user session.

FIG. 6 illustrates a system that facilitates automatic collaboration of a user session that employs machine-learning techniques.

FIG. 7 illustrates a methodology for automatic collaboration among users of a map application.

FIG. 8 illustrates a methodology for collaboration of map application information among users.

FIG. 9 illustrates a methodology for requesting and allowing users to participate in a current map session.

FIG. 10 illustrates a block diagram of a computer operable to execute the disclosed embodiments.

FIG. 11 illustrates a schematic block diagram of an exemplary computing environment operable to execute the disclosed embodiments.

### DETAILED DESCRIPTION

Various embodiments are now described with reference to the drawings. In the following description, for purposes of explanation, numerous specific details are set forth in order to provide a thorough understanding of one or more aspects. It may be evident, however, that the various embodiments may be practiced without these specific details. In other instances, well-known structures and devices are shown in block diagram form in order to facilitate describing these embodiments.

As used in this application, the terms “component, “module,” “system,” and the like are intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers.

The word “exemplary” is used herein to mean serving as an example, instance, or illustration. Any aspect or design described herein as “exemplary” is not necessarily to be construed as preferred or advantageous over other aspects or designs.

Various embodiments will be presented in terms of systems that may include a number of components, modules, and the like. It is to be understood and appreciated that the various systems may include additional components, modules, etc. and/or may not include all of the components, modules, etc. discussed in connection with the figures. A combination of these approaches may also be used. The various embodiments disclosed herein can be performed on electrical devices including devices that utilize touch screen display technologies and/or mouse-and-keyboard type interfaces. Examples of such devices include computers (desktop and mobile), smart phones, personal digital assistants (PDAs), and other electronic devices both wired and wireless.

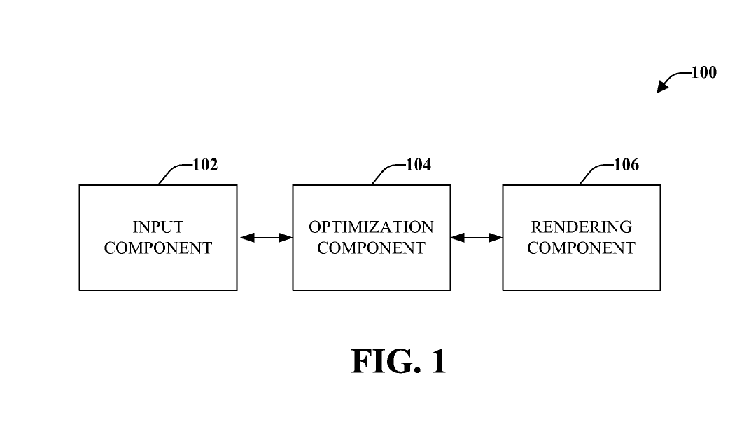

Referring initially to FIG. 1, illustrated is a system 100 that facilitates an interactive map application. System 100 and other embodiments are described and depicted herein in connection with various applications (e.g. real time communication, mapping) to facilitate understanding of the novel aspects presented herein. It is to be appreciated that the embodiments are not limited to a particular type or brand of communication application or mapping application and that any suitable application in accordance with the embodiments can be employed. In addition, the various embodiments disclosed herein are not limited to maps and can include other types of information, such as pictures, photos, videos, word-processing documents, etc. that are of interest to the multiple users and with which the users want to collaborate.

System 100 can allow two or more users and/or entities (e.g., the Internet, another system, a computer, . . . ), hereinafter referred to as users, to collaborate using a shared mapping system or application that can include a real time communication system or application. Such multiple users can participate in planning an event or trip, discovering points of interest, picking out a venue, obtaining driving directions, and the like, in a collaborative environment. The multiple users can view themselves and other participants on the map at their real time locations (e.g. though a locating means, such as Wi-Fi, Global Positioning System (GPS), triangulation, and so forth) and derive useful information to make collective decisions based on their real time location. Thus, the mapping application can be a shell for real time messaging and collaboration.

In some embodiments, system 100 can allow multiple users to participate in a project (e.g., an engineering project, a planning project, and the like) that involves drawing tools or objects annotations on a map, illustration, photo, video, and so forth in real time. A multitude of other uses can also be applied to collaborate on a common display and common annotations.

System 100 includes an input component 102 that can accept an input from a user or entity (e.g., the Internet, another system, a computer, . . . ) that allows users to share map and map browsing information. System 100 allows the one or more users to utilize the map interactively, which enables real time information exchange between users. Such information exchange can include the users' real time location, points of interest, driving directions, drawings, or changes on the map, and the like.

An input component 102 can accept an input from a first user. The input can be a reference point in a map application, such as a location or a particular point of reference (e.g., restaurant, museum, building, home, and so on), a text message, a voice message, a driving direction, etc. In some embodiments, the input can be a state of a map application of the first user. For example, a user can create a route or label portions or areas of a map or perform other functions in relation to a mapping application. Such information can be shared interactively with other users in a manner enabling the users to view similar information at substantially the same time. Annotations can be saved for later retrieval purposes.

Optimization component 104 can provide the input from the first user to other users during a real time communication session that includes a mapping session. The users can interact in a real time or back and forth (interactive) manner to discuss or modify various features of the mapping application. For example, if one user adds to the map information about such user's location, this information can be disseminated to the other session users at substantially the same time. Thus, from the perspective of the users, they are viewing substantially the same displayed information. This can be useful for engineers, architects, or others that are working on a project but may be in areas remote from each other or wish to enter information separately.

Rendering component 106 can be configured to display the real time communication session and map session to the multiple users. The displayed information can include any exchanged information and modifications to the mapping environment. The rendering component 106 can further be configured to provide (output data to) the multiple users who have the ability to individually retrieve requested information and navigate the image data in a three-dimensional manner. The three-dimensional rendering can be a plurality of navigation angles (e.g., oblique-view, bird's eye angle, aerial view, perspective angle, top viewing angle, front viewing angle, downward trajectory, upward trajectory, . . . ). However, the changes made by each user are propagated through system 100 and displayed to the other users at substantially the same time as the changes are being applied. In such a manner, all users of a particular session are sharing a same state as it relates to the viewed information.

System 100 can be implemented on a client machine or on a server utilizing an application program interface (API), such as an instant communication application and a web browsing application. As known, APIs facilitate building software applications through a set of routines, protocols, and tools, wherein developers and/or programmers can employ the API to construct customized applications consistent with the operating environment and a user(s) needs. Employing common APIs reduces learning curves and enables developers and/or programmers to focus on business needs.

For example, a server can synchronize the information between the multiple client machines. The server can receive an input from a first client machine and automatically implement that input on the other client machines that are involved in the session. In some embodiments, system 100 can be implemented individually on each client machine where a first client machine instructs one or more other client machine involved in the session to implement a similar change.

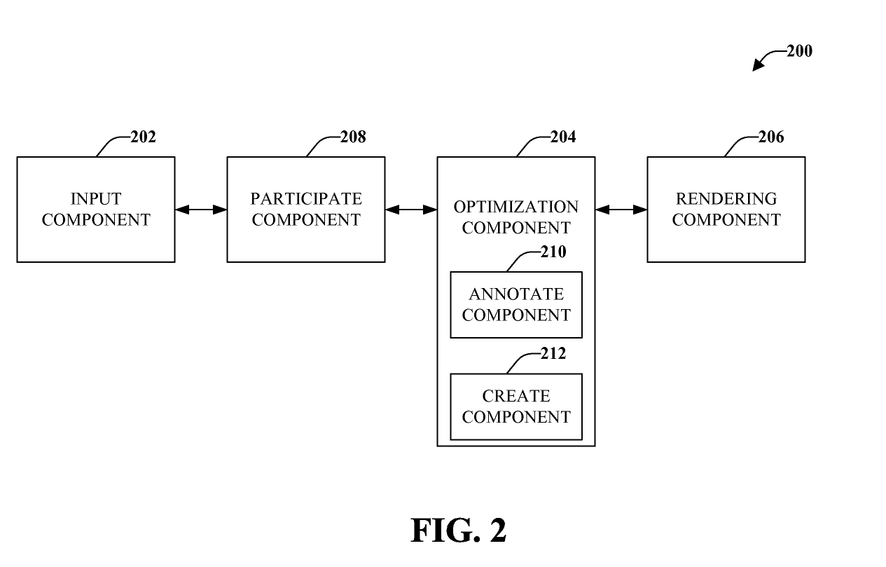

FIG. 2 illustrates a system 200 that provides interactive map sessions between two or more users. Similar to the system of the above figure, system 200 can be implemented on a server or on a client machine. System 200 can allow a user to invite other users to share a session in order to communicate to such other users location related information or other collaboration information. Such information can includes driving directions to a house, points of interest in real time, etc., which provides users the ability to interact (e.g., ask questions, carry on a conversation) and provide additional information relating to the users, the location information, or other interests of the users. Other information can include changes to a document, photo, or other items so that the users can collaborate in a real-time manner.

System 200 includes an input component that can be configured to receive information from one or more user in connection with collaboration of a map session among multiple users.

Also included in system 200 is a rendering component 206 that can be configured to display the map and other information (e.g. communication thread) to the multiple users, wherein all users view the same data or share the same mapping state or condition of the map. Rendering component 206 can present the mapping information in a multiple of viewing angles. For example, a viewing angle of the map can be an oblique view wherein the appearance of the map can be twisted or turned about forty-five degrees allowing the user to view the map from at least four viewpoints (e.g. north, south, east, and west). There is a plurality of other viewing angles available including a panoramic view and/or a three-dimension view of the map. The map can be angled at forty-five degrees allowing viewing of the sides of buildings and the roofs of buildings, if desired. This is referred to as a pictometry image and allows the user to switch from an over-view or top-view to an oblique view, etc. and the user can switch back and forth between the various types of view. The oblique view allows the user to choose a minimum of two rotation angles that can be, for example, based upon the street directions. The user may also import rotations providing maximum flexibility and a unique user experience. It should be noted that any change in the viewing angle is disseminated to each user participating in the session.

A participate component 208 can also be included in system 200 and can be configured to receive from a user a request to share a map application state of a first user with the at least a second user. Participation component 208 can be configured to notify the other user(s) that a request has been sent for them to join the session. If accepted, rendering component 206 can display to all accepting participants the state of the first user. Thereafter, any of the participants can modify the mapping information, thus altering the displayed map as presented to the other users.

In some embodiments, participation component 206 can maintain the identities of the participants confidential. For example, if a multitude of users are viewing the same area and wish to discuss the information with each other, the participants can communicate without having a relationship with each other (e.g., included on a contact list). This allows the users to communication in the current session and collaborate information without knowing the identity of the other participants.

Optimization component 204 can include an annotate component 210 and a create component 212. However, either or both annotate component 210 and create component 212 can be individual components. Create component 212 can be configured to allow collaboration, exchange, and/or save of location information. For example, users can create collections or create and save objects and entities on a map.

Annotation component 210 can be configured to annotate information to the map application based in part on the input from the users. Thus, as one or more user adds, deletes, or modifies information, such information is dynamically applied to the mapping session and displayed to the other users. If two or more users are alternating data at substantially the same time, annotate component can apply the changes in a predetermined manner. For example, each change can be applied based on a time-stamp of the change, or based on a ranking of each user, or any other manner.

Annotate component 210 may, in addition or alternatively, be configured to only allow a single user to modify data at a time. In such a manner, two or more users are not duplicating efforts or canceling out the changes made by another. Thereafter, input component 202 can accept at least a second user input and the annotation component 210 can update the map application with the at least a second user input. The rendering component 206 can automatically and selectively display the updated map application to the multiple users.

System 200 can facilitate providing to a plurality of users map information including information about the world as it is at the time the user is viewing the map (“right now”). The map information can include real time traffic, a skyscraper under construction, interior spaces, or anything else that can be perceived and for which a user desires information. The map information can include personalized location-based (distance, relevance, etc.) results, including directions and navigations results.

According to some embodiments, the map information can include detailed information regarding an object or point of interest. For example, information regarding a name of a building or other structure can be provided upon request. Other information regarding the structure can also be provided, such as telephone numbers, email alias information, web-site information, hours of operation, special events, etc. This information can be provided within the footprint or boundary of the object (e.g., rooftop dimensions) or it can be located on a display near the object or point of interest with a pointer indicating that the information belongs to that particular object or point of interest. In some embodiments the information can be located elsewhere on the map.

It should be noted that the input component described and illustrated can provide various types of user interfaces. For example, the input component can provide a graphical user interface (GUI), a command line interface, and the like. For example, a GUI can be rendered that provides a user with a region or means to load, import, read, etc. information, and can include a region to present the results of such. These regions can comprise known text and/or graphic regions comprising dialogue boxes, static controls, drop-down-menus, list boxes, pop-up menus, as edit controls, combo boxes, radio buttons, check boxes, push buttons, and graphic boxes. In addition, utilities to facilitate the presentation such as vertical and/or horizontal scroll bars for navigation and toolbar buttons to determine whether a region will be viewable can be employed. For example, the user can interact with the applications (e.g., mapping, real time communication) or other components by entering the information into an edit control.

The user can also interact with the regions to select and provide information through various devices such as a mouse, a roller ball, a keypad, a keyboard, a pen and/or voice activation, for example. Typically, a mechanism such as a push button or the enter key on the keyboard can be employed subsequent entering the information in order to facilitate information conveyance. However, it is to be appreciated that the disclosed embodiments are not so limited. For example, merely highlighting a check box can initiate information conveyance. In another example, a command line interface can be employed. For example, the command line interface can prompt (e.g., by a text message on a display and an audio tone) the user for information by providing a text message. The user can then provide suitable information, such as alphanumeric input corresponding to an option provided in the interface prompt or an answer to a question posed in the prompt. It is to be appreciated that the command line interface can be employed in connection with a GUI and/or API. In addition, the command line interface can be employed in connection with hardware (e.g., video cards) and/or displays (e.g., black and white, and EGA) with limited graphic support, and/or low bandwidth communication channels.

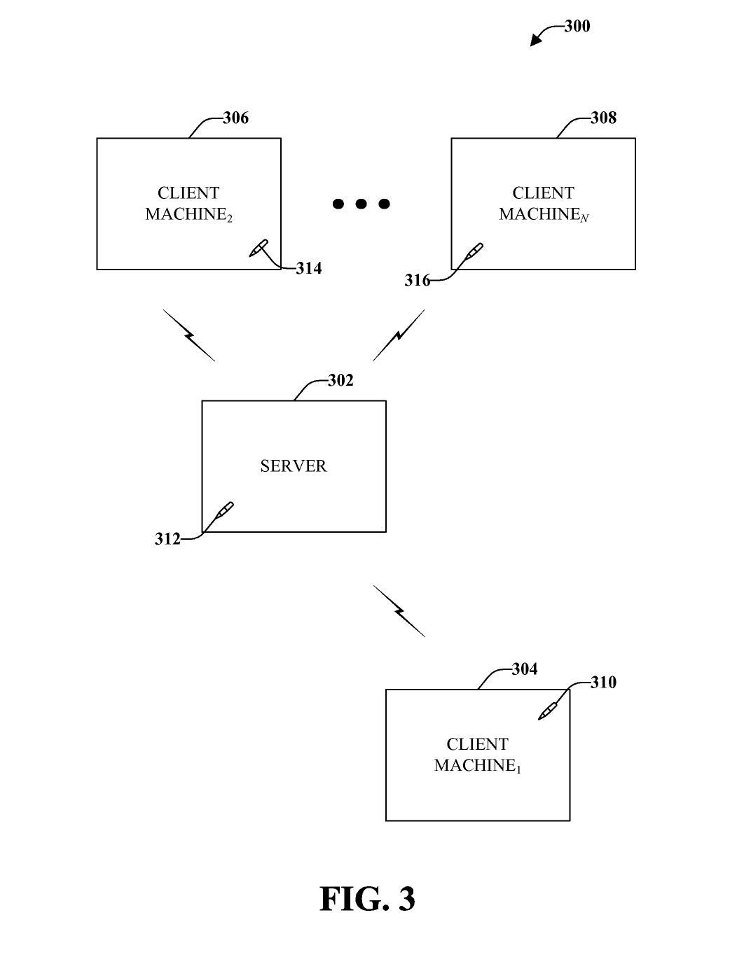

FIG. 3 illustrates a schematic representation of a communications system 300 in accordance with the disclosed embodiments. A server 302 can implement wired or wireless communication between a first client machine, labeled client machine₁ 304, and a second client machine, labeled client machine₂ 306, or more client machines, labeled client machine_{N} 308, where N is an integer greater to or equal to one.

The server 302 can provide each client machine 304, 306, 308 with a common viewing area, such as a map of a particular city, state, location, etc. For example, a first user on client machine₁ 304, can be viewing a location on a map and decide that the information should be shared with one or more contact or other user, using respective client machines 306, 308. Such user can invite the others to participate and view what the first user is viewing. For each user that accepts the invitation to participate, server 302 can facilitate the same information being displayed to each user though respective client machines 304, 306, 308.

The first user on client machine₁ 304, annotates the display, such as by drawing an arrow pointing to a particular place, pointing out points of interest, adding information to a scratch pad or note pad included in the mapping session, or other annotations. Such changes are illustrated by marking pen 310, however, it should be understood that various means of annotating a map or other document can be utilized. Such means can include a keyboard, a mouse, audible means, etc. The annotation can be the first user moving the map around to view a particular area or zooming in or out to display a smaller or larger area of the map. Still other changes include entering a search request and displaying the results of such a search, and so forth.

The server 302 receives the change from the first user, at 312, and disseminates the changes 314, 316 to the other users through respective client machines 306, 308. In such a manner, each user is seeing substantially the same information at substantially the same time as the change is made. If another user makes a change, such as user of client machine₂ 306, the change is disseminated by server 302, to the other client machines 304, 308. If two or more users enter information or make an annotation to the map, the order of applying the change to the other users can be disseminated using a predefined order or ranking of users. For example, the initiator (e.g., first user that invited the other users) has priority and such users changes are implemented first, etc. However, various other algorithms, methods, and/or techniques can be employed to determine how to implement changes made at substantially the same time.

In some embodiments, the server 302 does not implement or synchronize the changes on the client machines 304, 306, 308. For example, the client machines 304, 306, 308 can communicate directly to synchronize the changes among each other. If a modification is made on a client machine, such as machine₂ 306, this machine communicates with the other machines 304, 308 and instructs those machines to make the same changes. For example, if a user pans to the right, the other machines are instructed to pan to the right in the same amount.

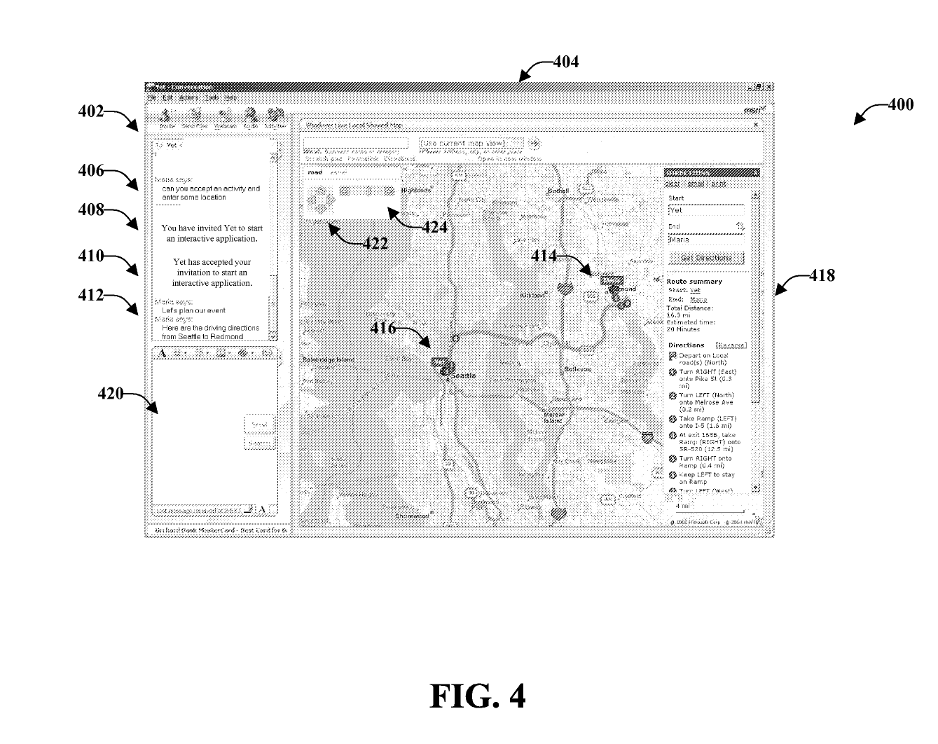

FIG. 4 illustrates an exemplary screen shot 400 of an user session. As illustrated, two users are viewing driving directions between their respective locations. It should be understood that more than two users can be involved in the same session and information is shared among the multiple users. Such information can be real time location information provided by a Global Positioning Service (GPS) or another locating means can be employed to facilitate location information. Real time communication between two or more users 402 can be integrated with a mapping application 404. A first user can send a communication (e.g., text, voice, video, and the like) 406 to one or more other users in conjunction with a request to participate in a mapping session 408. The other user can accept (or deny) the request, at 410, and the session can begin between the users with additional communication, at 412. While only communication from one user is depicted, it should be understood that the other users could also provide communication information. In addition, such communication can be in various forms (e.g., audio, video, and the like) and the communication can occur off-line (e.g., over a telephone line).

The users can also communicate through various information or annotations relating to the mapping application 404. Such annotations can include a location for the first user 414 and a location for a second user 416. Such location can be an actual location as determined by a location device (e.g. GPS, Wi-Fi, and so forth) or an entered location (e.g. home, place of business, and so on). In the example shown, route directions 418 between the location 414 and 416 are overlaid over the mapping application 404.

The users can enter additional communication, such as in a display screen 420. The users can pan or move around the image (e.g., move north, south, east, west, or a combination of these directions) 422 or change the granularity (e.g., zoom in or zoom out) 424 of the mapping application 404. Various other features can be provided through the real time communication application 404, the mapping application 404, or both.

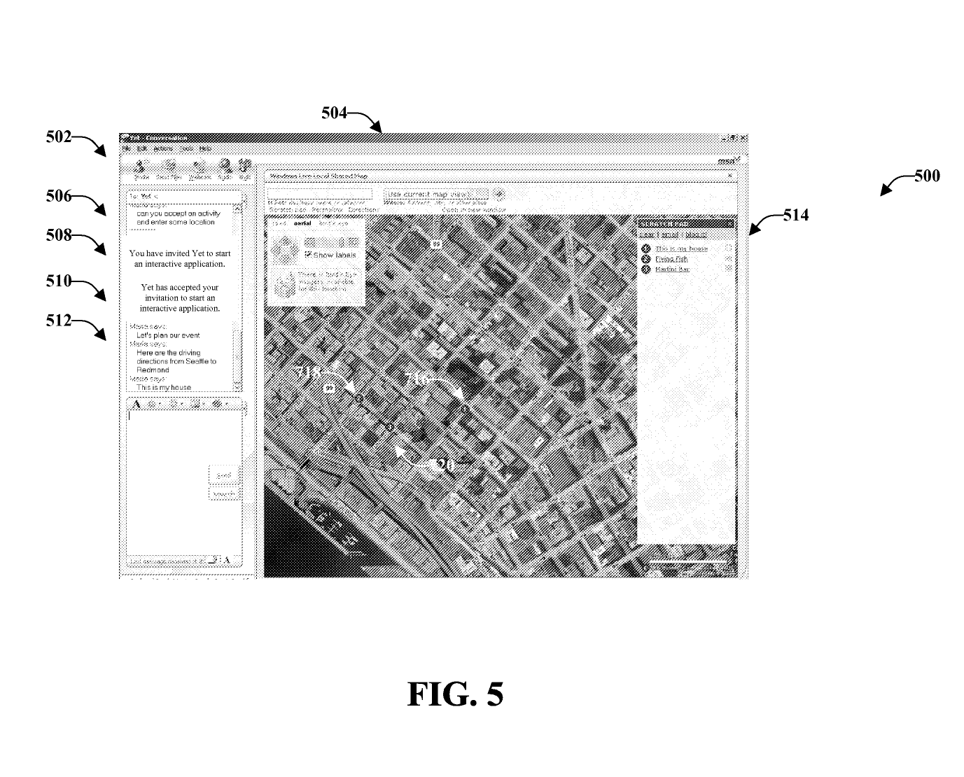

FIG. 5 illustrates another exemplary screen shot 500 of an user session. Two users can interact though a real time communication application 502 and a mapping application 504 to share mapping information. Similar to the above figure, a first user can send a communication (e.g., text, voice, video, and the like) 506 to one or more other user in conjunction with a request to participate in a mapping session 508. The other user can accept (or deny) the request, at 510, and the session can begin between the users with additional communication, at 512. While only communication from one user is depicted, it should be understood that the other users can also provide communication information, as well as other features as described with reference to the above figure.

Information can be entered by one or more user, illustrated at 514, for various locations. These locations can be indicated on the map, as illustrated at 516, 518, 520, allowing the users to view similar information at substantially the same time. Such information 514-520 can prompt user discussion that can occur in the communication application 502 or off-line.

Thus, several people as a group can share a mapping application session in real time. This enables users to discover location specific information, such as points of interest, driving directions, locations of entities, etc. in a collaborative fashion. It also allows users participating in the application session to exchange real time location. Sharing relevant information such as points of interest, driving directions, annotations, and the like is available in a collaborative environment. The multiple users can create a drawing or a plan directly on the map in a collaborative manner.

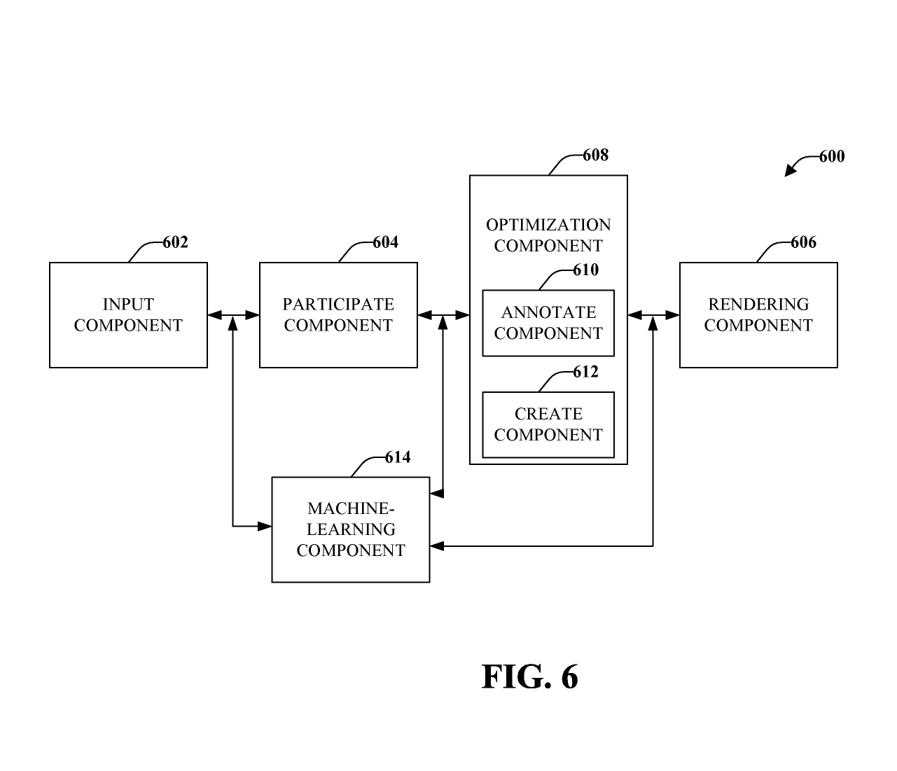

FIG. 6 illustrates a system 600 that facilitates automatic collaboration of a user session that employs machine-learning techniques. System 600 includes an input component 602 that accepts an input from a first user. An optimization component 604 can be included that provides the input from the first user to at least a second user during a session that includes a map application. Also included can be a rendering component 606 that can be configured to display the map application and the exchanged information to the first user and the at least a second user.

In accordance with some embodiments, the input component 602 can accept a second (or subsequent) input and the annotation component 604 updates the map application with the second (or subsequent) input, the rendering component 606 can automatically display the updated map application to the users. The first user input can be a point of reference in a map application, a text message, a voice message, a driving direction, and the like. The rendering component 606 can further selectively display the map application and annotated information based on a user state. In addition or alternatively, the rendering component 606 displays to another user the state of the first user if the other user accepts the request to share the map application state of the first user.

In accordance with some embodiments, the system can further include an annotation component 608 that annotates information to the map application based in part on the input from the first user. System may include a participation component 610 that receives from the first user a request to share a map application state of the first user with one or more other users and notifies the other user(s) of the request. In still another embodiment, system can include a create component 612 that allows at least one of collaboration, exchange, and save of location information.

With respect to taking automatic action, machine-learning techniques (e.g., artificial intelligence, rules-based logic, and so forth) can be implemented to facilitate performing automatic action, though a machine-learning component 614. The various embodiments (e.g., in connection with collaborating annotations in a session) can employ various Artificial Intelligence based schemes for carrying out various aspects thereof. For example, a process for determining if a state change for a map session can be facilitated through an automatic classifier system and process. Moreover, where multiple changes are made at the same or a similar time, the classifier can be employed to determine which change to employ in a particular situation or in which order to implement the changes.

A classifier is a function that maps an input attribute vector, x=(x1, x2, x3, x4, xn), to a confidence that the input belongs to a class, that is, f(x)=confidence(class). Such classification can employ a probabilistic and/or statistical-based analysis (e.g., factoring into the analysis utilities and costs) to prognose or infer an action that a user desires to be automatically performed. In the case of mapping applications or real-time communication applications, for example, attributes can be words or phrases or other data-specific attributes derived from the words (e.g., location names) and the classes are categories or areas of interest (e.g., location types, such as hotel, restaurant, and so forth).

A support vector machine (SVM) is an example of a classifier that can be employed. The SVM operates by finding a hypersurface in the space of possible inputs, which hypersurface attempts to split the triggering criteria from the non-triggering events. Intuitively, this makes the classification correct for testing data that is near, but not identical to training data. Other directed and undirected model classification approaches include, e.g. naive Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated from the subject specification, the one or more embodiments can employ classifiers that are explicitly trained (e.g. through a generic training data) as well as implicitly trained (e.g., by observing user behavior, receiving extrinsic information). For example, SVM's are configured through a learning or training phase within a classifier constructor and feature selection module. Thus, the classifier(s) can be used to automatically learn and perform a number of functions, including but not limited to determining according to a predetermined criteria which changes to implement first, etc. The criteria can include, but is not limited to, the amount of data or resources to modified, the type of data, the importance of the data, the user modifying the data, etc.

As it relates to rule-based logic, a user can establish a rule that can require a trustworthy flag and/or certificate to access a predefined type of resource whereas, other resources within a particular application may not require such security credentials. It is to be appreciated that any preference can be effected through pre-defined or pre-programmed in the form of a rule. It is to be appreciated that the rules-based logic can be employed in addition to or in place of the Artificial-Intelligence based logic.

In accordance with some embodiments, rules based logic can be employed wherein an implementation scheme (e.g. rule) can be applied to control and/or regulate state changes or participation of users. It will be appreciated that the rules-based implementation can automatically and/or dynamically regulate access and authentication based upon a predefined criterion. In response thereto, the rule-based implementation can grant and/or deny access by employing a predefined and/or programmed rule(s) based upon any desired criteria (e.g. data type, data size, data importance, database owner, caller identity . . . ).

By way of example, a user can establish a rule that can require a trustworthy flag and/or certificate to access a predefined type of resource whereas, other resources within a particular database or map application may not require such security credentials. It is to be appreciated that any preference can be effected through pre-defined or pre-programmed in the form of a rule.

In view of the exemplary systems shown and described above, methodologies that may be implemented in accordance with the disclosed subject matter are discussed. While, for purposes of simplicity of explanation, the methodologies are shown and described as a series of blocks, it is to be understood and appreciated that the claimed subject matter is not limited by the number or order of blocks, as some blocks may occur in different orders and/or concurrently with other blocks from what is depicted and described herein. Moreover, not all illustrated blocks may be required to implement the methodologies described hereinafter. It is to be appreciated that the functionality associated with the blocks may be implemented by software, hardware, a combination thereof or any other suitable means (e.g. device, system, process, component). Additionally, it should be further appreciated that the methodologies disclosed hereinafter and throughout this specification are capable of being stored on an article of manufacture to facilitate transporting and transferring such methodologies to various devices. Those skilled in the art will understand and appreciate that a methodology could alternatively be represented as a series of interrelated states or events, such as in a state diagram.

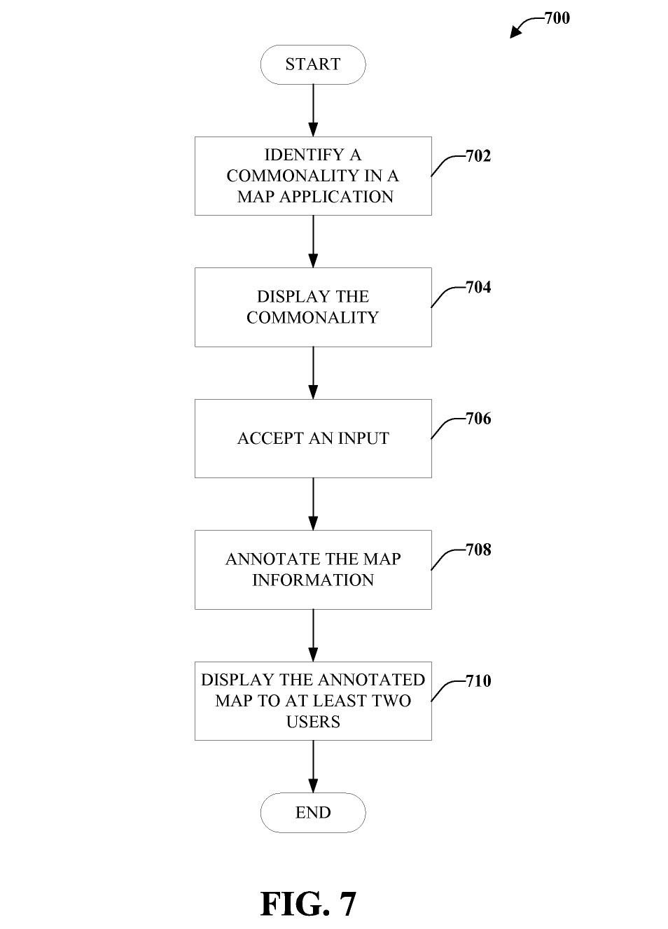

FIG. 7 illustrates a methodology 700 for automatic collaboration among users of a map application. Method 700 starts, at 702, where commonalities in a map application are identified. The commonalities can include a common reference point, a common user state, or the like. A common reference point can be utilized when two or more users desire to view a similar location at substantially the same time, such as to facilitate a discussion regarding the location. A common user state can be utilized when a first user desires to share such user's current state with at least a second user. In this scenario, the first user does not have to specify a location since it is the state (e.g., viewing activity) of the first user that is shared with the other users.

At 704, the commonality and the map application are displayed to the multiple users. In such a manner, the users are viewing substantially the same information at substantially the same time. At 706, an input is accepted for a user. The input can be a point of reference, a text message, a voice message, a driving direction, any change to the displayed information (e.g., panning, zooming, . . . ), and the like. At substantially the same time as receipt of the first input, that map application is annotated, at 708, with the information. The resulting annotated map application is displayed to the users that are participating in the session.

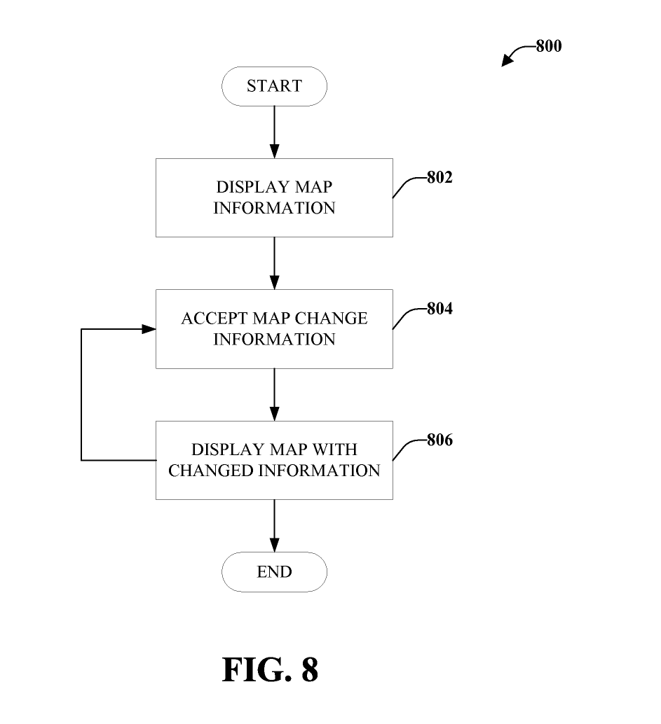

FIG. 8 illustrates a methodology 800 for collaboration of map application information among users. Method 800 starts, at 802, with displaying map application information. Such information can be displayed in substantially the same manner as that shown and described with reference to the above figure. At 804, map change information is accepted from one or more user. Such change information can include an exchange of map application information between two or more users. At 806, the map with the changed information is displayed to the session users. Such display can be automatically updated based on the exchanged information.

The method 800 can return to 804, with acceptance of a subsequent map change. It is to be understood that this act can be recursive such that any number of changes can be made to the map and such changes are automatically applied to the viewing session of the users participating in the mapping session. As such, a second (or subsequent) input can be received and the map application is updated with the input information. The updated map application is displayed to the session users.

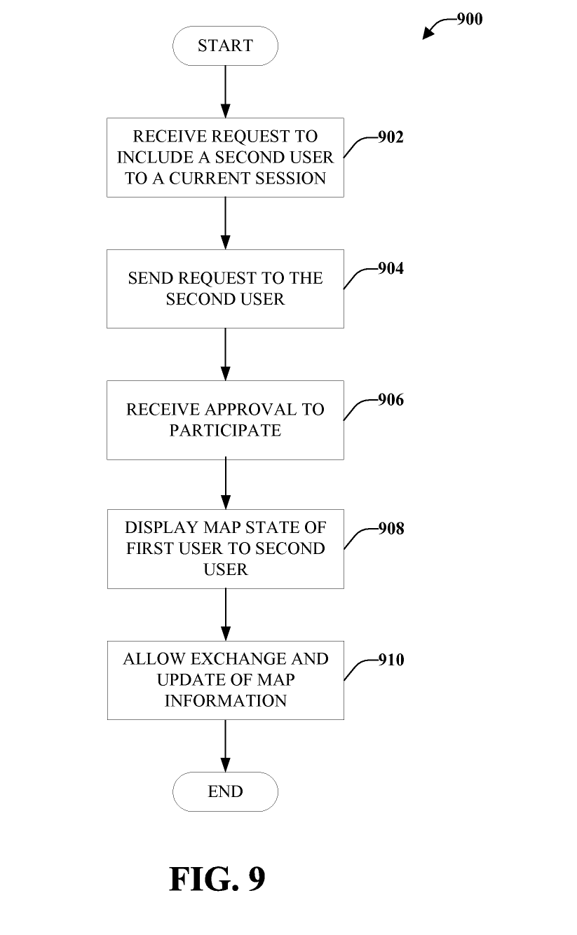

FIG. 9 illustrates a methodology 900 for requesting and allowing users to participate in a current map session. Method starts, at 902, where a request to include at least a second user to a current map session is received from a first user. The request is sent, at 904, to the subsequent users and can include various information regarding the first user (e.g., name title, reason for the participation request, or other information). If an approval, from the second user, to participate is received, at 906, the map state of the first user is displayed to the second user, at 908. The first and subsequent users can exchange map information, at 910, wherein such exchanged map information is automatically updated and displayed to each user. For example, if a map granularity change is requested by any user, the granularity of the displayed map for the other users is also changed.

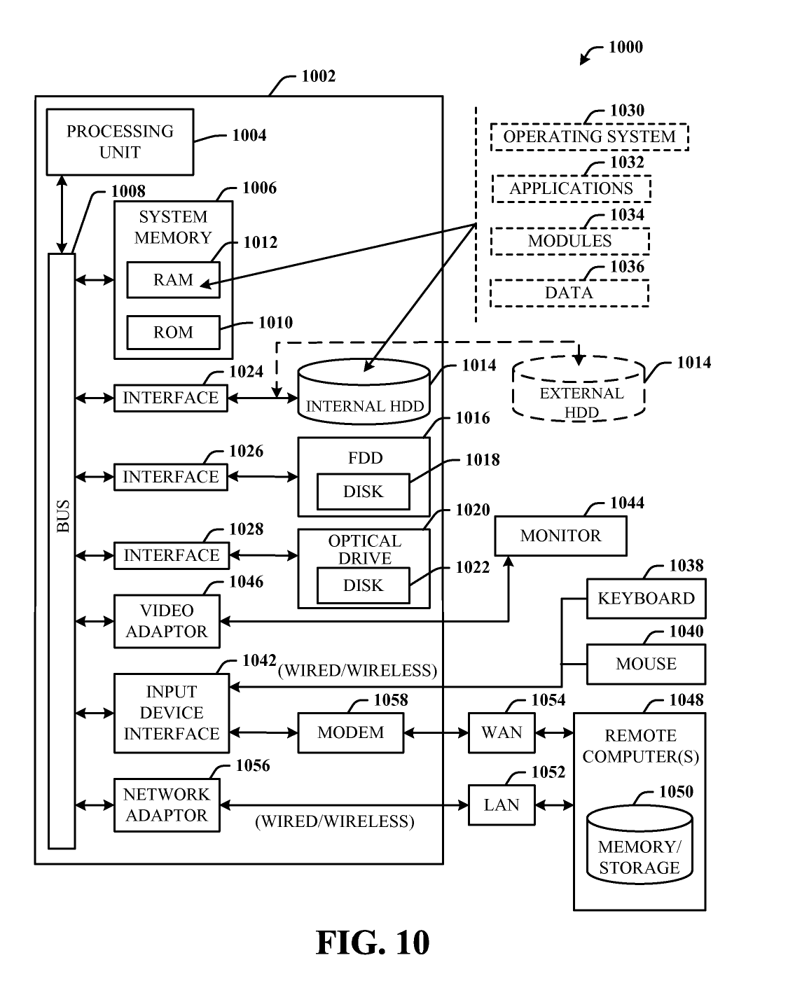

Referring now to FIG. 10, there is illustrated a block diagram of a computer operable to execute the disclosed architecture. In order to provide additional context for various aspects disclosed herein, FIG. 10 and the following discussion are intended to provide a brief, general description of a suitable computing environment 800 in which the various aspects can be implemented. While the one or more embodiments have been described above in the general context of computer-executable instructions that may run on one or more computers, those skilled in the art will recognize that the various embodiments also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and nonvolatile media, removable and non-removable media. By way of example, and not limitation, computer-readable media can comprise computer storage media and communication media. Computer storage media includes both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital video disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

With reference again to FIG. 10, the exemplary environment 1000 for implementing various aspects includes a computer 1002, the computer 1002 including a processing unit 1004, a system memory 1006 and a system bus 1008. The system bus 1008 couples system components including, but not limited to, the system memory 1006 to the processing unit 1004. The processing unit 1004 can be any of various commercially available processors. Dual microprocessors and other multi-processor architectures may also be employed as the processing unit 1004.

The system bus 1008 can be any of several types of bus structure that may further interconnect to a memory bus (with or without a memory controller), a peripheral bus, and a local bus using any of a variety of commercially available bus architectures. The system memory 1006 includes read-only memory (ROM) 1010 and random access memory (RAM) 1012. A basic input/output system (BIOS) is stored in a non-volatile memory 1010 such as ROM, EPROM, EEPROM, which BIOS contains the basic routines that help to transfer information between elements within the computer 1002, such as during start-up. The RAM 1012 can also include a high-speed RAM such as static RAM for caching data.

The computer 1002 further includes an internal hard disk drive (HDD) 1014 (e.g., EIDE, SATA), which internal hard disk drive 1014 may also be configured for external use in a suitable chassis (not shown), a magnetic floppy disk drive (FDD) 1016, (e.g., to read from or write to a removable diskette 1018) and an optical disk drive 1020, (e.g., reading a CD-ROM disk 1022 or, to read from or write to other high capacity optical media such as the DVD). The hard disk drive 1014, magnetic disk drive 1016 and optical disk drive 1020 can be connected to the system bus 1008 by a hard disk drive interface 1024, a magnetic disk drive interface 1026 and an optical drive interface 1028, respectively. The interface 1024 for external drive implementations includes at least one or both of Universal Serial Bus (USB) and IEEE 1394 interface technologies. Other external drive connection technologies are within contemplation of the one or more embodiments.

The drives and their associated computer-readable media provide nonvolatile storage of data, data structures, computer-executable instructions, and so forth. For the computer 1002, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing the methods disclosed herein.

A number of program modules can be stored in the drives and RAM 1012, including an operating system 1030, one or more application programs 1032, other program modules 1034 and program data 1036. All or portions of the operating system, applications, modules, and/or data can also be cached in the RAM 1012. It is appreciated that the various embodiments can be implemented with various commercially available operating systems or combinations of operating systems.

A user can enter commands and information into the computer 1002 through one or more wired/wireless input devices, e.g. a keyboard 1038 and a pointing device, such as a mouse 1040. Other input devices (not shown) may include a microphone, an IR remote control, a joystick, a game pad, a stylus pen, touch screen, or the like. These and other input devices are often connected to the processing unit 1004 through an input device interface 1042 that is coupled to the system bus 1008, but can be connected by other interfaces, such as a parallel port, an IEEE 1394 serial port, a game port, a USB port, an IR interface, etc.

A monitor 1044 or other type of display device is also connected to the system bus 1008 through an interface, such as a video adapter 1046. In addition to the monitor 1044, a computer typically includes other peripheral output devices (not shown), such as speakers, printers, etc.

The computer 1002 may operate in a networked environment using logical connections through wired and/or wireless communications to one or more remote computers, such as a remote computer(s) 1048. The remote computer(s) 1048 can be a workstation, a server computer, a router, a personal computer, portable computer, microprocessor-based entertainment appliance, a peer device or other common network node, and typically includes many or all of the elements described relative to the computer 1002, although, for purposes of brevity, only a memory/storage device 1050 is illustrated. The logical connections depicted include wired/wireless connectivity to a local area network (LAN) 1052 and/or larger networks, e.g. a wide area network (WAN) 1054. Such LAN and WAN networking environments are commonplace in offices and companies, and facilitate enterprise-wide computer networks, such as intranets, all of which may connect to a global communications network, e.g., the Internet.

When used in a LAN networking environment, the computer 1002 is connected to the local network 1052 through a wired and/or wireless communication network interface or adapter 1056. The adaptor 1056 may facilitate wired or wireless communication to the LAN 1052, which may also include a wireless access point disposed thereon for communicating with the wireless adaptor 1056.

When used in a WAN networking environment, the computer 1002 can include a modem 1058, or is connected to a communications server on the WAN 1054, or has other means for establishing communications over the WAN 1054, such as by way of the Internet. The modem 1058, which can be internal or external and a wired or wireless device, is connected to the system bus 1008 through the serial port interface 1042. In a networked environment, program modules depicted relative to the computer 1002, or portions thereof, can be stored in the remote memory/storage device 1050. It will be appreciated that the network connections shown are exemplary and other means of establishing a communications link between the computers can be used.

The computer 1002 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from home, in a hotel room, or at work, without wires. Wi-Fi is a wireless technology similar to that used in a cell phone that enables such devices, e.g. computers, to send and receive data indoors and out; anywhere within the range of a base station. Wi-Fi networks use radio technologies called IEEE 802.11 (a, b, g, etc.) to provide secure, reliable, fast wireless connectivity. A Wi-Fi network can be used to connect computers to each other, to the Internet, and to wired networks (which use IEEE 802.3 or Ethernet). Wi-Fi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 10BaseT wired Ethernet networks used in many offices.

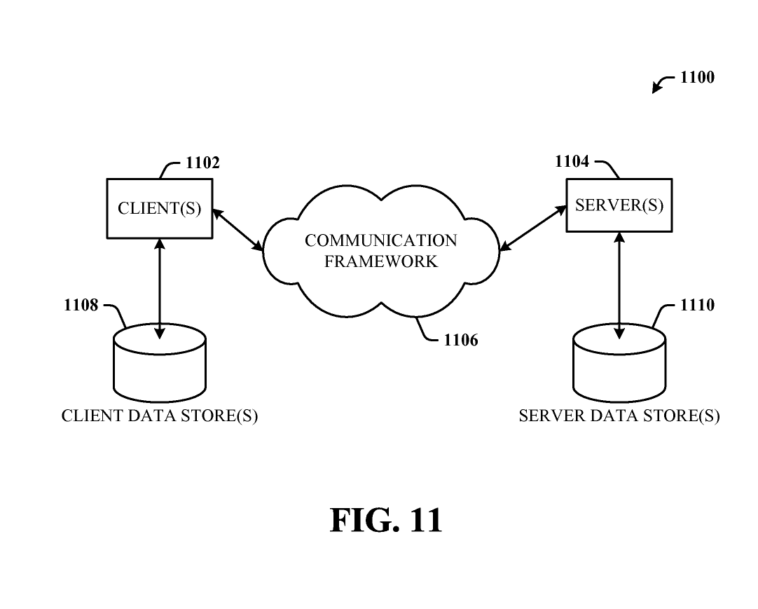

Referring now to FIG. 11, there is illustrated a schematic block diagram of an exemplary computing environment 1100 in accordance with the various embodiments. The system 1100 includes one or more client(s) 1102. The client(s) 1102 can be hardware and/or software (e.g. threads, processes, computing devices). The client(s) 1102 can house cookie(s) and/or associated contextual information by employing the various embodiments, for example.

The system 1100 also includes one or more server(s) 1104. The server(s) 1104 can also be hardware and/or software (e.g., threads, processes, computing devices). The servers 1104 can house threads to perform transformations by employing the various embodiments, for example. One possible communication between a client 1102 and a server 1104 can be in the form of a data packet adapted to be transmitted between two or more computer processes. The data packet may include a cookie and/or associated contextual information, for example. The system 1100 includes a communication framework 1106 (e.g., a global communication network such as the Internet) that can be employed to facilitate communications between the client(s) 1102 and the server(s) 1104.

Communications can be facilitated through a wired (including optical fiber) and/or wireless technology. The client(s) 1102 are operatively connected to one or more client data store(s) 1108 that can be employed to store information local to the client(s) 1102 (e.g., cookie(s) and/or associated contextual information). Similarly, the server(s) 1104 are operatively connected to one or more server data store(s) 1110 that can be employed to store information local to the servers 1104.

What has been described above includes examples of the various embodiments. It is, of course, not possible to describe every conceivable combination of components or methodologies for purposes of describing the various embodiments, but one of ordinary skill in the art may recognize that many further combinations and permutations are possible. Accordingly, the subject specification intended to embrace all such alterations, modifications, and variations that fall within the spirit and scope of the appended claims.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects. In this regard, it will also be recognized that the various aspects include a system as well as a computer-readable medium having computer-executable instructions for performing the acts and/or events of the various methods.

Furthermore, the one or more embodiments may be implemented as a method, apparatus, or article of manufacture using standard programming and/or engineering techniques to produce software, firmware, hardware, or any combination thereof to control a computer to implement the disclosed embodiments. The term “article of manufacture” (or alternatively, “computer program product”) as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the disclosed embodiments.

In addition, while a particular feature may have been disclosed with respect to only one of several implementations, such feature may be combined with one or more other features of the other implementations as may be desired and advantageous for any given or particular application. Furthermore, to the extent that the terms “includes,” and “including” and variants thereof are used in either the detailed description or the claims, these terms are intended to be inclusive in a manner similar to the term “comprising.”

What is claimed is:

1. A system that facilitates interactive map application, comprising:
an input component that accepts an input from a first user; and
an optimization component that provides the input from the first user to at least a second user during a session that includes a map application; and
a rendering component that displays the map application and the exchanged information to the first user and the at least a second user.

2. The system of claim 1, further comprising an annotation component that annotates information to the map application based in part on the input from the first user input.

3. The system of claim 1, the input component further accepts at least a second user input and the annotation component updates the map application with the at least a second user input, the rendering component automatically displays the updated map application to the first and the at least a second user.

4. The system of claim 1, the first user input is at least one of a point of reference in a map application, a text message, a voice message, and a driving direction.

5. The system of claim 1, the rendering component selectively displays the map application and annotated information based on a user state.

6. The system of claim 1, further comprising a participation component that receives from the first user a request to share a map application state of the first user with the at least a second user and notifies the at least a second user of the request.

7. The system of claim 6, the participation component maintains the identity of the first user and the second user confidential.

8. The system of claim 6, the rendering component displays to the at least the second user the state of the first user if the at least a second user accepts the request to share the map application state of the first user.

9. The system of claim 1, further comprising a create component that allows at least one of collaboration, exchange, and save of location information.

10. The system of claim 1, a machine-learning component automates one or more system component.

11. A method for automatic collaboration among users of a map application, comprising:
identifying a commonality on a map application;
displaying the map application and the commonality to a first user and at least a second user;
accepting a first input;
annotating the map application with the first input; and
displaying the annotated map application to the first and the at least a second user.

12. The method of claim 11, the commonality is one of a common reference point and a common user state.

13. The method of claim 11, further comprising:
exchanging map application information between the first user and the at least a second user; and
automatically updating the displayed map application based on the exchanged information.

14. The method of claim 11, further comprising:
accepting at least a second input;
updating the map application with the second input; and
displaying the updated map application to the first and the at least a second user.

15. The method of claim 11, the first input is at least one of a point of reference, a text message, a voice message, and a driving direction.

16. The method of claim 11, further comprising:
receiving a map granularity change from the first user; and
changing the granularity of the displayed map for the first user and the at least a second user.

17. The method of claim 11, further comprising:
receiving a request from a first user to include at least a second user to a current session;
sending the request to the at least a second user; and
receiving an approval to include the at least a second user to the current session.

18. A system that facilitates session collaboration between multiple users, comprising:
means for receiving a request from a first user to invite at least a second user to a session;
means for communicating acceptance of the invite request;
means for displaying the information viewed by the first user to the at least a second user;
means for receiving a modification to the information from the first user; and
means for annotating the information viewed by the at least a second user with the modification.

19. The system of claim 18, further comprising:
means for receiving a modification from the first user and a modification from the at least a second user at substantially the same time; and
means for prioritizing the modifications for display to each user.

20. The system of claim 18, further comprising:
means for exchanging the information between the first user and the at least a second user; and
automatically updating a displayed area based on the exchanged information
